(19) United States
(12) Patent Application Publication
(10) Pub. No.: US 2010/0008491 A1
(43) Pub. Date: Jan. 14, 2010

(54) INTELLIGENT DIALING SYSTEM AND METHOD

(75) Inventor: Ehud Nahum, RaAnana (IL)

Correspondence Address: MARTIN D. MOYNIHAN d/b/a PRTSI, INC., P.O. BOX 16446, ARLINGTON, VA, 22215, US

(73) Assignee: Nameber Ltd

(21) Appl. No.: 12/305,407

(22) PCT Filed: Jun. 19, 2007
(86) PCT No.: PCT/IL2007/000738

§ 371 Date: Dec. 18, 2008

Related U.S. Application Data
(60) Provisional application No. 60/814,900, filed on Jun. 20, 2006.

(51) Int. Cl. H04M 3/42

(52) U.S. Cl. 379/216.01

(57) ABSTRACT

In a communication system, an intelligent dialing method comprising: receiving a dialing sequence relating to a business entity; in a switch in the communication system, checking for the geographical location; an IN data base checks the request to direct the call; the call is directed through the switch to the telephone line specified by the client to be the destined call area. In a communication system, an intelligent dialing method comprising: receiving a dialing sequence relating to a person's name and having a prefix indicating that intelligent dialing is to be activated; an IN data base checks the request to direct the call; the call is directed through a switch to the telephone line specified by the client to be the destined call area.

### CROSS-REFERENCE TO RELATED APPLICATIONS

The present application is related to, and claims priority from, the patent application No. U.S. 60/814,900 filed on 20 Jun. 2006 in U.S.A. by the present applicant and entitled “Intelligent dialing sequence assignment”.

### FIELD OF THE INVENTION

The present invention relates to intelligent dialing over wired and wireless systems using a sequence assignment.

### BACKGROUND OF THE INVENTION

Although the present application may detail, by way of example, various aspects of the invention with reference to the Israeli communications environment, it is to be understood that identical or similar considerations also apply for other countries.

The Israeli communications market is made up primarily of four cellular companies and two phone companies. Other companies are now entering the market through Voice Over IP (VOIP).

The leading phone company is Bezeq, a former Government-owned company. There are also the popular mobile phone companies. The usage of mobile phones is very popular in Israel and the amount of members listed in the cellular companies is bigger than the total population in the country. As of today, there are more than 7 million cellular members. In addition, the usage of Short Message Services (SMS) is also extremely popular among all age groups.

Bezeq provides phone line services for both the mobile companies and other phone companies. All in all, Bezeq provides services for all phone users.

As part of its service, Bezeq offers a toll-free dialing service (1-800), low cost numbers per call (1-700), direct business (IVR structure 1-599) and short form dial (Star(*)+four digit numbers).

Many business use Bezeq's services for the primary reason of being available to their customers, either through the short form dialing or through an easy to remember digit number with repeated digits.

Looking at the varied businesses that use the above services, most of them fall into the category of either a medium sized company to a large company. There are also small businesses that use these services to market their business this way: “Remember my number and call me toll-free.”

A disadvantage in this communication market is its success rate. Most business numbers have 10 digit repeatable numbers. The customers need to try and remember the wanted/needed number. Did they need/want 1800-656565 or 1800-565656? In the mobile market the situation is different. Most of the members do not have an easily memorable number and, therefore, if they cannot remember a number it is available on their cellular phone memory.

### SUMMARY OF THE INVENTION

The present disclosure relates to improvements in dialing systems and methods, as illustrated with the following examples:

According to one aspect of the invention,

1. Geographical Directory by Subject and Interest Domains

The end user will name-dial the domain he is looking for. For example, Veterinarian, Health care, Investment, etc. The dialing will be made based on the fonts used for SMS messages (each key represents Hebrew or English letters, although other languages may be used as the need be). Once the user named dialed, the directory will be made to the appropriate listing of the desired business, that is located in the same geographic area the call was made from.

For example, end users from geographical area A that will dial “1-800-invest” in any given language, depending on the country dialing from, will be directed to an investment company listed in area A. The country may be divided into areas and, in each area, businesses will be listed to provide services available in that geographic setting.

2. Personal Name Dialing in the Mobile Communication World

When it comes to the cellular numbers, there is no difference between one number to the next. Therefore, the dialing will be made using the letters on the keys (similar to SMS messages), wherein each key may represent letters in Hebrew or English. Using the present invention, rather than using a cellular area code and the cell number, the user will dial an acquaintance using his name or by any given identification, name or business name he requested.

For example, 054-seinfeld. The letters sequence is a standard numerical sequence that provides regular dialing to the customers that choose a name to be identified with. For example 054-master will be: 054-627837.

3. Creating a Private and Closed Net Connection in the Mobile Communication World for the Purpose of Name Dialing

Based on the idea of a unique name dialing to each addressee, the user will use the (cellular) phone keys, now used to send SMS messages, wherein each key may represent letters in Hebrew or English.

Using the present invention, rather than using a cellular area code and the cell number, the user will dial an acquaintance using his name or by any given identification name or business number he may have requested. For example, 054-seinfeld.

The difference is that this system may provide technical solutions to the following limitations, inter alia:

The mobile company will use a converting mechanism of their member's numbers, a virtual private network (also known as VPN) which converts a virtual name-number to an existing member's number and allows to refer the name calls to desirable and potential clients.

This system also allows to put to user shorter or longer numbers than prior art systems.

The new method allows a communication system to accept variable length dialing sequences.

Preferably, the communication system will accept variable length sequences. If the sequence to dial is longer than a standard number (ie in Israel, more than 7 digits) then the system may truncate the number to bring it to a dialing number of regular length. Other methods known in the art, such as N to M mapping, may be used to shorten the dialing sequence so as to bring it to the standard length which is acceptable for dialing in the system.

Further objects, advantages and other features of the present invention will become obvious to those skilled in the art upon reading the disclosure set forth hereinafter.

### BRIEF DESCRIPTION OF THE DRAWINGS

FIG. 1 illustrates a dialing method using a countrywide geographical directory by subject and interest domains

FIG. 2 illustrates a method for intelligent dialing over a wired network using time windows and time delays

### DETAILED DESCRIPTION OF THE PREFERRED EMBODIMENTS

A preferred embodiment of the present invention will now be described by way of example and with reference to the accompanying drawings.

1. Countrywide Geographical Directory by Subject and Interest Domains

The user will name dial the professional domain he is looking for.

Detailed process: A user dials (for example in one of two languages: the local language or English), for example as illustrated in Table 1 below:

TABLE 1

| | | | |
|---|---|---|---|
| Letters | Key Number | Letters | Key Number |

| | | | |
|---|---|---|---|
| [symbol] , MNO | 6 | [symbol] , ABC | 2 |
| [symbol] , PQRS | 7 | [symbol] , DEF | 3 |
| [symbol] , TUV | 8 | [symbol] , GHI | 4 |
| [symbol] , WXYZ | 9 | [symbol] , JKL | 5 |

Notes:
* The keys 0 and 1, in one embodiment, may not include letters
* This table is an example of a specific case in Israel, wherein each key contains letters in English and additional letters in Hebrew, for a total of 5 to 7 letters per key.
In other embodiments, letters in other languages may be used in a bi-lingual keypad.
Alternatively, letters of just one language or alphabet may be used.

Example of use: If the user wants to call a clinic, all he needs to do is dial 1-800-DOCTOR=1-800-326867 according to Table 1. The number dialed will appear on the phone screen. Then the directory will be made to the (listed) clinic that is located in the same geographic area the call was made from.

In the infrastructure, the 1-800 numbers may belong to an “intelligent network” (IN). This structure can identify the geographical location the call was made from to about 100 different areas. Different businesses may provide their services in each geographical area. The client will designate which number (a regular line, not 1-800) he would like the directory in the case of dialing from any one of the geographical areas.

The client is the business which uses the 1-800 number, he will decide the call routing for each area.

Other prefixes may be used for this service, for example (*).

A (*) prefix may be used in business, which may afford such an expensive arrangement.

The sequence after the (*) may be of variable length, according to the class or type of business the sequence may represent.

For private persons, a dedicated prefix, such as 060, may be used for the present service.

Preferably, the communication system will accept variable length sequences. If the sequence to dial is longer than a standard number (ie in Israel, more than 7 digits) then the system may truncate the number to bring it to a dialing number of regular length. Other methods known in the art, such as N to M mapping, may be used to shorten the dialing sequence so as to bring it to the standard length which is acceptable for dialing in the system.

Call Method 1

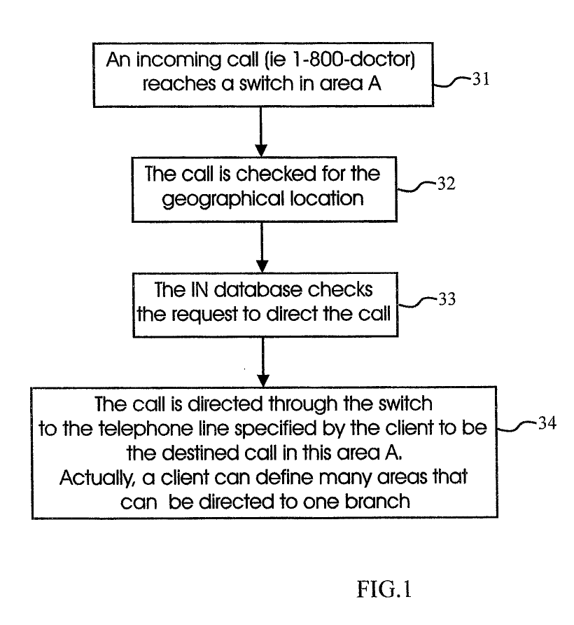

The method includes, see FIG. 1:

1. An incoming call (ie 1-800-doctor) reaches a switch in area A (31)

2. the call is checked for the geographical location (32)

3. the IN data base checks the request to direct the call (33)

4. the call is directed through the switch to the telephone line specified by the client to be the destined call in this area A. Actually, a client can define many areas that can be directed to one branch. (34)

** End of method **

2. Personal Name Dialing in the Mobile Communication World

To facilitate the dialing process between people and/or businesses, the letters located on phone keys will be used.

Using the present invention, rather than dialing a cellular area code and the cell number, the user will dial an addressee, using his name/identification/nickname or the business name he requested.

For example, 054-seinfeld. The letters sequence is a standard numerical sequence that provides regular dialing to the customers that choose a name to be identified with. For example 054-master will be: 054-627837.

Preferably, the communication system will accept variable length sequences. If the sequence to dial is longer than a standard number (ie in Israel, more than 7 digits) then the system may truncate the number to bring it to a dialing number of regular length. Other methods known in the art, such as N to M mapping, may be used to shorten the dialing sequence so as to bring it to the standard length which is acceptable for dialing in the system.

Dialing Method 2

The method includes: A user dials according to the letters that appear on the phone keys, each key contains one number and possibly also letters. The letters may be in two languages, English and the local language, for example as illustrated in Table 1.

** End of method **

Example of use: If the user wants to call Michael Jackson in the mobile company using the prefix 054, all he needs to do is dial 054-JACKSON=054-5225766 according to the chart. The number dialed will appear on the phone screen.

The directory will then make the required numbers translation to actually dial to the desired addressee, according to the number that dialed and identified with.

The above method assumes that Mr. Michael Jackson was the first to register the domain name Jackson to be used with his number, with the cellular service provider.

If someone else (incidentally also named Jackson) was first to register his name, then that other person will be called when dialing as above detailed.

In the infrastructure, the cellular name-number entries are descanted from the cellular numbers and are not different than any other numbers.

3. Creating a Virtual Private Network in the Mobile Communication World for the Purpose of Name Dialing

Based on the idea of a unique name dialing to each addressee, the user will use the (cellular) phone keys, now used to send SMS messages, wherein each key may represent letters in Hebrew or English.

Using the present invention, rather than using a cellular area code and the cell number, the user will dial an acquaintance using his name/identification/nickname or the business name he requested.

For example, 054-seinfeld.

The letters sequence is represented as a standard numerical sequence that provides for regular dialing to the customers that choose a name to be identified and remembered with.

The difference is that this system may provide technical solutions to the following limitations, inter alia:

The mobile company will use a converting mechanism of their member's numbers, such as a virtual private network (also known as VPN) which converts a virtual name-number entry to an existing member's number and allows to refer the name calls to desirable and potential clients. This does not imply that the client is obligated to change his old number with a new one that fits his name; rather, the system transfers calls to him through conversion charts.

Likewise, the conversion mechanism allows to use shorter or longer numbers than the standard numbers (ie area code+7 digits in Israel).

For the same reason, the virtual number is also converted into a real one.

Examples of Use of the Invention:

A. A unique virtual area code for name-number entries. For example, 060 in which, after the arrival of a numerical sequence, either short or long, the number pattern will be received and converted into the member's regular phone numbers.

The communication system will include means for accepting a variable length dialing sequence and for adapting it to the length acceptable for dialing in the system, for example 7 digits in Israel.

B. Usage of the regular cellular area with a first unique digit (X) after the area code and then differentiate the needed client's names. Using this segregation will allow to define in the conversion mechanism, that every number in the system that was dialed with an X after the area code will be transformed to conversion.

Dialing Method Using Time Delays

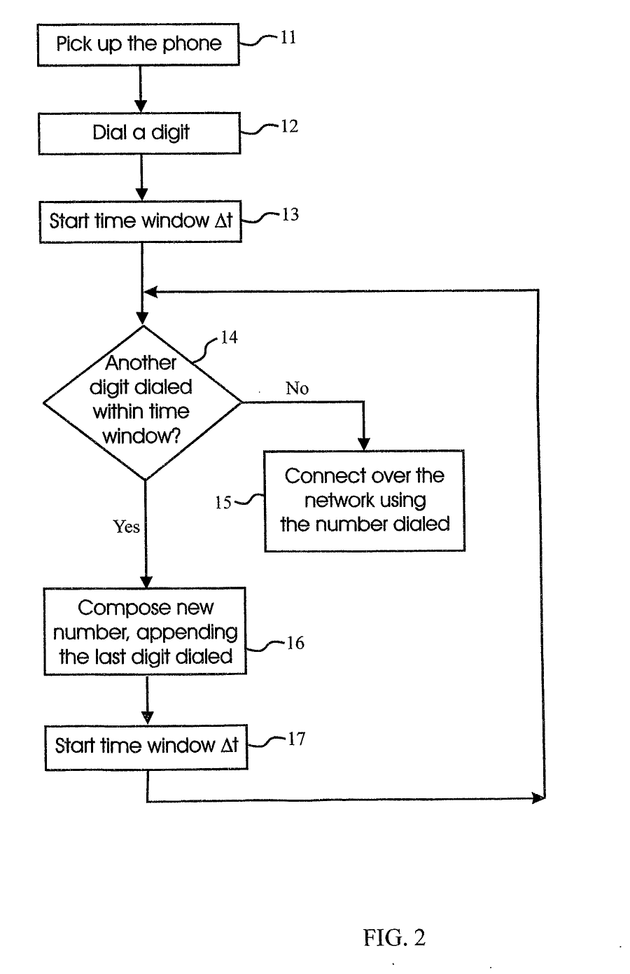

FIG. 2 illustrates a method for intelligent dialing over a wired network using time windows and time delays to detect the end of the variable length sequence, including:

1. Pick up the phone 11

2. Dial a digit 12

3. Start time window delta_t 13

4. Another digit dialed within the time window? 14 if Yes goto (16)

5. Connect over the network using the number dialed 15

6. Compose new number, appending the last digit dialed 16

7. Start time window delta_t 17; goto (14)

** End of method **

Call Method Type A

1. Incoming call, such as 060-TomCruise, reaches the cellular switch

2. the call is checked in the conversion chart for “Tom Cruise” to which number this needs to be converted to

3. the call is directed through the switch to the destined cellular line.

** End of method **

Call Method Type B

1. Incoming call, such as 054-X-TomCruise, reaches the cellular switch

2. the call is checked in the conversion chart for “Tom Cruise” to which number this needs to be converted to

3. the call is directed through the switch to the destined cellular line.

** End of method **

It will be recognized that the foregoing is but one example of an apparatus and method within the scope of the present invention, and that various modifications will occur to those skilled in the art upon reading the disclosure set forth hereinbefore.

1-6. (canceled)

7. An intelligent dialing method comprising:
(a) selecting, by a user, a name to be dialed from a plurality of different length names, each of which has an associated access number with a same prefix;
(b) dialing a special character as said prefix in a communication system;
(c) dialing a sequence comprising a series of numbers corresponding to said access number, one digit per letter of said name, after (b), in said communication system;
(d) at a switch in the communication system, converting said sequence according to a conversion chart to provide a conversion result; and
(e) directing a call to a destination via said switch based on said conversion result.

8. A method according to claim 7, wherein said communication system has a plurality of prefixes, each with a set dialing length post-prefix and wherein said dialed sequence is of a length different from any of the set lengths.

9. A method according to claim 8, wherein said length is longer than any of the set lengths.

10. A method according to claim 7, wherein said prefix is an asterix.

11. A method according to claim 10, wherein a length of said sequence is greater than 4.

12. A method according to claim 7, wherein said sequence is detected using time windows and time delays.

13. A method according to claim 7, wherein said name is selected from a group consisting of: a domain, subject, an interest, a professional domain, a business name, a personal name, a name related to a business entity, an identification and a nickname.

14. A method according to claim 7, wherein said communication network provides different conversions for different geographical locations, by using different charts at different switches of a same communication system which forms a part of said network.

15. A method according to claim 7, wherein said chart includes at least 4 numbers of at least 3 different lengths, for a same prefix.

16. A method according to claim 7, comprising converting said dialed sequence into a real access number.

17. A method according to claim 7, comprising converting said dialed sequence into a shorter access number.

18. A method according to claim 7, comprising repeating (a)-(e) with a dialing sequence of a different length.

19. A method according to claim 7, comprising associating a plurality of dialing sequences with a plurality of business entities such that the number of digits in each dialing sequence matches the length of a name associated with the entities.

20. A communication system comprising at least one switch, said switch including:
(a) a receiver which receives a prefix and a dialing sequence of variable length for the prefix;
(b) a convertor which converts different received sequences into different access numbers, using a directory chart; and
(c) a switching section which routs a call according to said access numbers.

21. A system according to claim 20, wherein said receiver is configured to receive fixed length dialing sequences for some prefixes and variable length sequences for at least one other prefix.
